(19) United States
(12) Patent Application Publication
(10) Pub. No.: US 2010/0047748 A1
(43) Pub. Date: Feb. 25, 2010

(54) SYSTEM AND METHOD FOR STUDYING A FOREIGN LANGUAGE IN A VEHICLE

(75) Inventor: Jin Man Hwang, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/342,730

(22) Filed: Dec. 23, 2008

(30) Foreign Application Priority Data
Aug. 19, 2008 (KR) 10-2008-0080819

(51) Int. Cl. G09B 19/06; G09B 5/00

(52) U.S. Cl. 434/157; 434/307 R

(57) ABSTRACT

The present invention relates to a system and method for studying a foreign language in vehicle, including a multimedia terminal checking the ability of foreign language of a user by comparing foreign language study data of the user with foreign language study data of a native speaker which has been stored in advance; and a remote controller sending a study start command, and a study end command to the multimedia terminal through a local wireless communication.

### CROSS-REFERENCE TO RELATED APPLICATION

This application claims under 35 U.S.C. §119(a) the benefit of Korean Patent Application No. 10-2008-0080819 filed on Aug. 19, 2008, the entire contents of which are incorporated herein by reference.

### BACKGROUND OF THE INVENTION

The present invention relates to a system for studying a foreign language in a vehicle and a method thereof, more particularly, to a system for studying a foreign language in a vehicle and a method thereof, which is capable of enhancing the convenience for the user by enabling the user to study a foreign language while driving a vehicle.

Studying a foreign language can be performed by various methods, such as, but not limited to, attending lectures in a special private institute, on-line lectures, and self-study using a cassette tape. However, when one studies a foreign language in a special private institute and, for example, conversing directly with teachers, typically considerable time and money is needed. In the case of on-line lectures, although the cost is less than the case of special private institutes, an additional location and time for study computer and a headset should be prepared.

In addition, when one studies by themselves using a tool such as the cassette tape, it can be difficult to check his or her pronunciation of the foreign language.

The above information disclosed in this the Background section is only for enhancement of understanding of the background of the invention and therefore, it may contain information that does not form the prior art that is already known in this country to a person of ordinary skill in the art.

### SUMMARY OF THE INVENTION

In one aspect, the invention provides a system for studying a foreign language in a vehicle.

In one embodiment, the system for foreign language study in vehicle includes a multimedia terminal checking the ability of foreign language of a user by comparing foreign language study data of the user with foreign language study data of a native speaker which has been stored in advance; and a remote controller sending a study start command, and a study end command to the multimedia terminal through a local wireless communication. In accordance with further embodiments of the invention, the multimedia terminal grades the user's foreign language pronunciation and stores study history information.

In accordance with the other preferred embodiments of the invention, the steering wheel remote controller preferably includes, but is not limited to, a Bluetooth module performing the local wireless communication with the multimedia terminal; a study start button pressed at the start of a foreign language study; and study end button pressed at the end of the foreign language study. In accordance with other preferred embodiments of the invention, the multimedia terminal preferably includes, but is not limited to, a Bluetooth module performing the local wireless communication with the remote controller; a study data base storing a foreign language study data and the study history information of the native speaker; and a controller grading the foreign language study data of the user by comparing the foreign language study data of the user with that of the native speaker, and outputting the native speaker's foreign language study data of a next word when the grade is higher than a given score, while re-outputting a corresponding word when the grade is lower than a given score.

In accordance with further preferred embodiments of the invention, the controller outputs the native speaker's foreign language pronunciation for the latest study word by making reference to the study history information from the study database, when the controller suitably receives a study start command from the remote controller.

In accordance with further preferred embodiments of the invention, the controller simultaneously performs a foreign language study with other users through a chat room, when the controller is preferably requested to open a chat room or searches a list of the opened chat rooms so that a desired chat room is selected by the user.

In accordance with another preferred embodiment of the invention, the controller compares the score of the user with the score of other users, when the controller suitably performs the foreign language study with other users through the chat room.

In accordance with another preferred embodiment of the invention, the multimedia terminal further comprises a multi-channel speaker for exchanging foreign language study data of the user with that of another user. In accordance with further embodiments of the invention, a system for foreign language study in a vehicle further comprises a microphone which receives the foreign language study data of the user and sends it to the multimedia terminal through the local wireless communication. In accordance with still other further embodiments of the invention, a system for foreign language study in a vehicle comprises a remote controller that is a steering wheel remote controller.

In accordance with further preferred embodiments of the invention, a system for foreign language study in a vehicle further comprises a microphone which receives the foreign language study data of the user and preferably sends it to the multimedia terminal through the local wireless communication.

According to another preferred embodiment of the invention, a method for foreign language study in vehicle suitably includes searching a foreign language study word when a study start command is suitably inputted through Bluetooth wireless communication; outputting foreign language study data of a native speaker corresponding to the foreign language study word, and receiving foreign language study data for the foreign language study word from a user through Bluetooth wireless communication; and evaluating and grading the foreign language study data received from the user by comparing it with the foreign language study data of the native speaker, and determining the continuation of the study for the foreign language study word according to the grade.

In accordance with another further embodiment of the invention, a method for foreign language study in vehicle further includes storing study history information including a study score, a study start time, and a study end time when a study end command is inputted.

In accordance with yet another preferred embodiment of the invention, determining the continuation of the study for the foreign language study word comprises outputting native speaker's foreign language study data for a next word when the grade is higher than a given, while requesting the re-pronunciation for a corresponding word when the grade is lower than a given score.

In accordance with a further embodiment of the invention, searching a foreign language study word preferably comprises searching a latest study word, and indicating a study word list when the latest study word does not exist so that the study word is suitably selected by the user.

In accordance with one embodiment of the invention, a method for foreign language study in vehicle includes: selecting a chat room by opening the chat room or searching a chat room list, when a user of a vehicle requests the chat mode; simultaneously performing foreign language study with other users through the chat room; and evaluating the foreign language study score of the user and comparing it with a foreign language study score of the other users.

In accordance with another preferred embodiment of the invention, simultaneously performing foreign language study includes: searching a foreign language study word; and outputting foreign language study data of a native speaker corresponding to the foreign language study word, and receiving foreign language study data for the foreign language study word from a user through Bluetooth wireless communication.

In accordance still another embodiment of the invention, comparing a foreign language study score comprises grading the foreign language study data received from the user by comparing it with the foreign language study data of the native speaker.

In accordance a further embodiment of the invention, the score and the comparison result are sent to a study support center to be recorded.

The invention described herein enables the user to study a foreign language, for example to study foreign language pronunciation, while driving a vehicle, such as when commuting to work, and thus suitably enhances convenience of study.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a configuration diagram of a foreign language studying system in vehicle according to an embodiment of the present invention.

FIG. 2 is a flowchart showing a foreign language study method in vehicle according to an embodiment of the present invention.

FIG. 3 is a graph showing the history of foreign language study time according to an embodiment of the present invention.

FIG. 4 is a flowchart showing a foreign language studying method in vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use in the environment.

### DETAILED DESCRIPTION OF THE EMBODIMENTS

As described herein, in one aspect, the present invention includes a system for studying a foreign language in vehicle, the system comprising a multimedia terminal that checks the foreign language ability of a user; and a remote controller.

In one embodiment, the multimedia terminal checks the ability of foreign language of a user by comparing foreign language study data of the user with foreign language study data of a native speaker, wherein the foreign language study data of a native speaker has been stored in advance.

In another embodiment, the remote controller sends a study start command and a study end command to the multimedia terminal through a local wireless communication.

In another aspect, the invention features a method for studying a foreign language in vehicle, the method comprising searching a foreign language study word when a study start command is inputted; outputting foreign language study data of a native speaker corresponding to the foreign language study word; receiving foreign language study data for the foreign language study word from a user; and evaluating and grading the foreign language study data received from the user.

In one embodiment, the study start command is inputted through Bluetooth wireless communication.

In another embodiment, the foreign language study data for the foreign language study word is received from a user through Bluetooth wireless communication.

In another further embodiment, the evaluating and grading the foreign language study data received from the user is carried out by comparing it with the foreign language study data of the native speaker.

In still another embodiment, the method further comprises the step of determining the continuation of the study for the foreign language study word according to the grade.

The invention also features a motor vehicle comprising the system for studying a foreign language in a vehicle of the aspects as described herein.

Hereinafter, exemplary embodiments of the present invention will be described in detail with reference to the exemplary attached drawings.

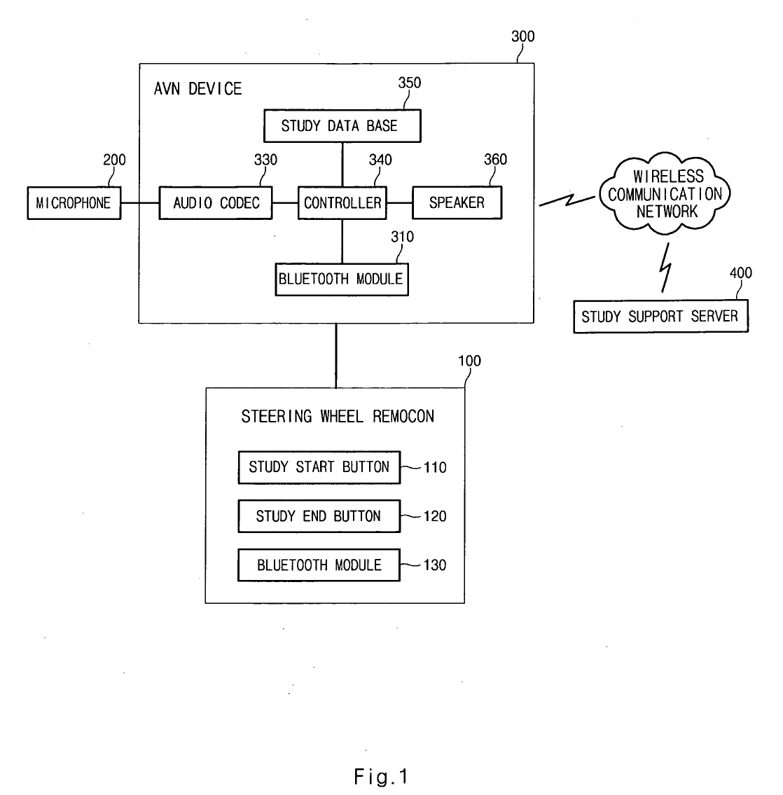

FIG. 1 is a configuration diagram of a foreign language studying system in a vehicle according to a preferred embodiment of the present invention.

According to certain embodiments, the foreign language studying system preferably includes, but is not limited only to, a steering wheel remote controller 100, a microphone 200, an AVN (Audio, Video, Navigation) device 300, and a study support server 400. Preferably, the steering wheel remote controller 100 is suitably mounted on a steering wheel (vehicle handle) such that a user is able to readily control the AVN device 300 through Bluetooth during the driving of a vehicle. For this, the steering wheel remote controller 100 includes a study start button 110, a study end button 120, and a Bluetooth module 130.

According to certain preferred embodiments, the study start button 110 sends a study start command to the AVN device 300 when it is pushed by the user, while the study end button 120 sends a study end command to the AVN device 300 when it is pushed by the user. In further embodiments, the Bluetooth module 300 performs a local wireless communication with the AVN device 300.

Preferably, the microphone 200 receives a foreign language pronunciation from a user. According to other preferred embodiments of the invention, it is desirable that the microphone 200 is suitably mounted at a position where the user is readily able to speak, such as the steering wheel, a rearview mirror, the front of driver's seat, or the collar of a user's coat.

in further exemplary embodiments, when the AVN device 300 suitably receives the study start command from the steering wheel remote controller 100, the AVN device 300 outputs the foreign language pronunciation of a native speaker for the latest word by making reference to the study history. Preferably, the AVN device 300 recognizes and decodes the foreign language pronunciation received from user through the microphone 200 to compare with the native speaker's pronunciation stored in a study database 350. The AVN device 300grades the foreign language pronunciation of the user, and outputs the natives speaker's foreign language pronunciation of a next word when the grade is suitably higher than a given score. In preferred embodiments, the native speaker is someone who speaks that language as their first language rather than having learned it as a foreign language.

According to further embodiments of the invention, the AVN device 300 preferably includes, but is not only limited to, a Bluetooth module 310, an audio codec 330, a controller 340, the study database 350, and a speaker 360. The Bluetooth module 310 performs a local wireless communication with the steering wheel remote controller 100. The audio codec decodes an audio signal of the user inputted from the microphone 200, and sends it to a controller 340.Accordingly, when the controller 340 receives the study start command from the steering wheel remote controller 100 through the Bluetooth module 310, the controller 340 outputs outputting the foreign language pronunciation of a native speaker for the latest study word through the microphone 200 by making reference to the study history information from the study database 350. Accordingly, in further exemplary embodiments, the latest study word is the last word that was studied, corresponding to a word which has a grade under a given score. Further, when the latest study word is not found, a study word list is displayed to be selected by the user.

In addition, in other exemplary embodiments, the controller 340 grades the audio signal received from the audio codec 330 by comparing with the native speaker's pronunciation information from the study database 350, and outputs the native speaker's pronunciation of a next word when the grade is suitably higher than a given score while re-outputting a corresponding word when the grade is lower than a given score. When the controller 340 receives the study end command from the steering wheel remote controller 100 through the Bluetooth module 310, the controller 340 stores the study history such as the study score and time into the study database 350.

In additional preferred embodiments, when the controller 340 is suitably requested to open a chat room or searches a list of the opened chat rooms so that the chat room is selected by the user, preferably, the controller 340 simultaneously performs a foreign language study with other user. In other additional embodiments, when the controller 340 performs a foreign language study with another user through the chat room, the controller 340 suitably compares the score of the user with the score of other user to send the result to the study support server 400. In this case, the other user can be a driver of another vehicle or a user of computer located at home, an office, or at an Internet cafe.

According to other preferred embodiments of the invention, the study database 350 stores a study word list, native speakers foreign language pronunciation data and study history information. According to further embodiments, the speaker 360 outputs native speaker foreign language pronunciation data and, preferably, is implemented with a multi-channel speaker for foreign language talk with other users. According to further embodiments, the study support server 400 provides native speaker foreign language pronunciation data to the AVN device 300 preferably through a wireless communication network, receiving the user's foreign language study history information from the AVN device 300 to manage it.

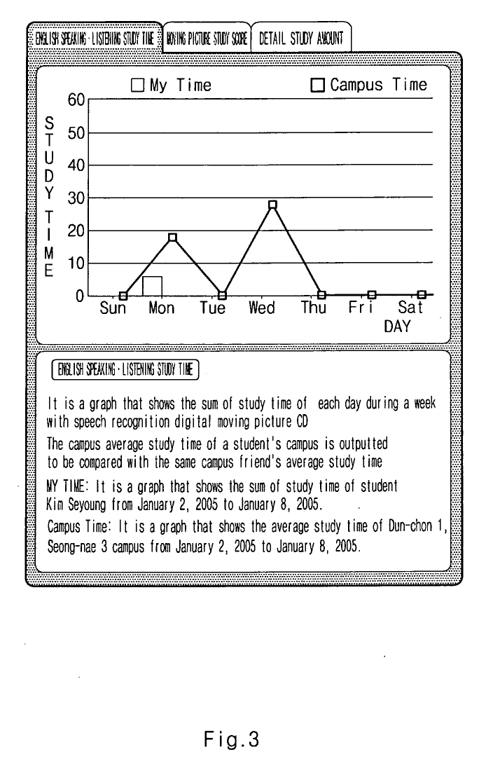

In other embodiments, the study support server 400 provides native speaker foreign language pronunciation data with a certain charge, and manages foreign language study history information, including a foreign language study course, study time, and a foreign language study score. In particular embodiments, the study support server 400 makes a graph of study time information as shown in FIG. 3 to display so that the user is able to suitably affirm the foreign language study history information through an Internet server at home or at an office.

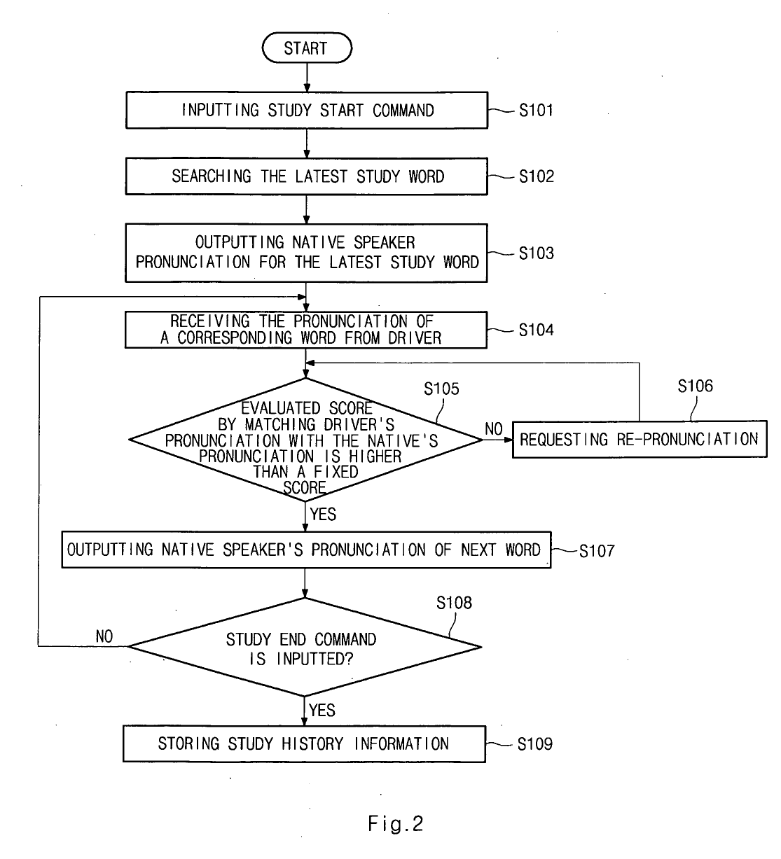

Hereinafter, a foreign language studying method in vehicle according to an embodiment of the present invention will be explained in detail with reference to exemplary FIG. 2.

In one embodiment, when a study start command is inputted from the steering wheel remote controller 100 (S101), the AVN device 300 searches the latest study word from the study history information stored in the study database 350 (S102), and suitably outputs native speaker foreign language pronunciation data corresponding to the latest study word through the speaker 360 (S103).

According to further embodiments, the AVN device 300 receives the pronunciation of a corresponding word from a user through the microphone 200 (S104), evaluating and grading the user's pronunciation by matching the user's foreign language pronunciation with the native speaker foreign language pronunciation (S105). In further exemplary embodiments, the AVN device 300 compares and analyzes the accent and intonation of the user's foreign language pronunciation with that of the native speaker foreign language pronunciation so that scores are ranked and tabulated as shown in Table 1.

TABLE 1

| No | study start | study end | accent | intonation | accuracy | average |
|---|---|---|---|---|---|---|
| 1 | 7.1 10:00 | 7.1. 11:00 | 83 | 75 | 79 | 79 |
| 2 | 7.2 12:00 | 7.2 13:00 | 87 | 78 | 82 | 82.3 |
| 3 | — | — | — | — | — | — |

Table 1 indicates an example in which an average score is calculated by using an accent score, intonation score, and accuracy score. However, according to certain embodiments, it is desirable that the scores are calculated by other variables.

In further preferred embodiments, the AVN device 300 suitably requests the user to re-pronounce a word when the evaluated score for the user's pronunciation is lower than a given score at step S105 (S106), and outputs the native speaker pronunciation of a next word when the evaluated score for the user's pronunciation is higher than a given score (S107).

Then, in further preferred embodiments, the AVN device 300 checks whether the study end command is suitably inputted from the steering wheel remote controller 100 (S108). In certain embodiments, for example in the case where the study end command is not inputted, it receives the pronunciation of the next word from the user. In other certain embodiments, for example in the case where the study end command is inputted the AVN device 300 stores the study history information including a study score, study start time, and study end time of the user into the study database 350 (S109).

Preferably, the AVN device 300 sends the study history information to the study support server 400 through a wireless communication network. Then, the study support server 400 manages the study history information and notifies the study history information through an Internet server so that the user is able to check the study history information through a computer at home or at the office.

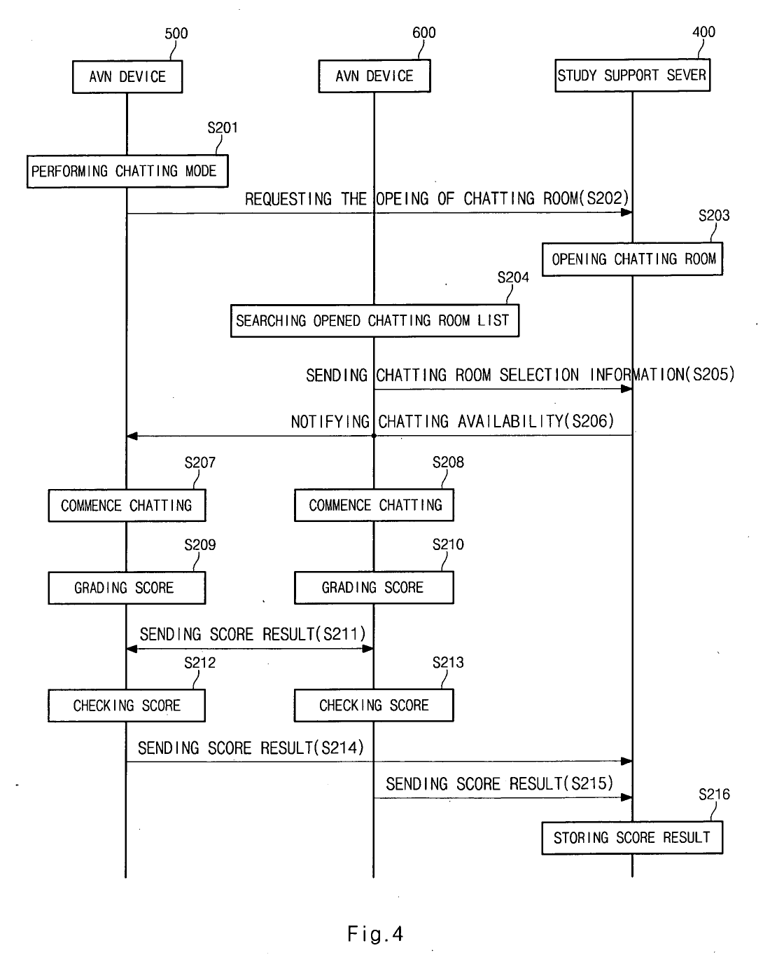

A foreign language talking method in vehicle according to preferred embodiments of the invention will be explained in detail with reference to FIG. 4.

According to one embodiment, an AVN device 500 of user 1 performs a chat mode (S201), and the study support server 400 opens a chat room (S203).

In further embodiments, an AVN device 600 of user 2 searches the opened chat room list (S204), sending a selected information to the study support server 400 after user 2 selects a desired chat room. According to related embodiments, user 2 is considered as a user of the other vehicle in FIG. 4, but it may preferably include a user who uses a computer at an office, home, or an Internet cafe.

In certain exemplary embodiments, the study support sever 400 sends the chat room availability to the AVN device 500 of user 1 and the AVN device 600 of user 2 respectively (S205). According to preferred embodiments, the opening of the chat room may suitably include the opening of a network or a channel.

Accordingly, in exemplary embodiments, the AVN device 500 of user 1 and the AVN device 600 of user 2 commence a foreign language chat respectively in the same chat room (S207, S208). According to certain preferred embodiments, the foreign language chat can be performed by pronouncing the same foreign language pronunciation, or by talking or listening for foreign language dialogue.

In further preferred embodiments, each AVN device 500, 600 suitably grades the score of the foreign language pronunciation, the accent, and the intonation (S209, S210), and sends the score to each other (S211), so that each user can suitably check one's own score and the counterpart's score (S212, S213). In this way, the foreign language pronunciation game can be done. In this case, in further embodiments, the score can be added or deducted according to the response time of the user in the chat room. Accordingly, the user receives a score deduction when the response time exceeds the time limit. In exemplary embodiments, each AVN device 500, 600 performs communication through a wireless communication network.

In further embodiments of the invention, the score and the result of the game can be suitably indicated with the test of any language, for example English text or Korean text or can be guided with a voice output for a safe driving, and it is preferable that the foreign language pronunciation of users can be heard. Then, each AVN device 500, 600 send scores to the study support server 400 respectively (S214, S215). Preferably, the study support server 400 stores the score and the game record (S216).

The invention preferably provides an example of opening a chat room and manages a channel or a network for chatting on the study support server 400, however, a vehicle information center or a telematics information center can manage this instead of the study support server 400.

In addition, the invention preferably provides an example of using an AVN, but the invention also can be suitably applied to a multimedia terminal including a telematics terminal and an audio device.

As described, the invention enables a driver to able to practice a foreign language pronunciation, preferably through Bluetooth by using a driving time in a vehicle without an additional study place, an additional headset, and an additional computer.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system for studying a foreign language in vehicle, the system comprising:
a multimedia terminal checking the ability of foreign language of a user by comparing foreign language study data of the user with foreign language study data of a native speaker which has been stored in advance; and
a remote controller sending a study start command, and a study end command to the multimedia terminal through a local wireless communication.

2. The system in claim 1, wherein the multimedia terminal grades the user's foreign language pronunciation and stores study history information.

3. The system in claim 1, wherein the remote controller comprises:
a Bluetooth module performing the local wireless communication with the multimedia terminal;
a study start button pressed at the start of a foreign language study; and
a study end button pressed at the end of the foreign language study.

4. The system of claim 2, wherein the multimedia terminal comprises:
a Bluetooth module performing the local wireless communication with the remote controller;
a study data base storing a foreign language study data and the study history information of the native speaker; and
a controller grading the foreign language study data of the user by comparing the foreign language study data of the user with that of the native speaker, and outputting the native speaker's foreign language study data of a next word when the grade is higher than a given score, while re-outputting a corresponding word when the grade is lower than a given score.

5. The system in claim 4, wherein the controller outputs the native speaker's foreign language pronunciation for the latest study word by making reference to the study history information from the study database, when the controller receives a study start command from the remote controller.

6. The system in claim 4, wherein the controller simultaneously performs a foreign language study with other users through a chat room, when the controller is requested to open a chat room or searches a list of the opened chat rooms so that a desired chat room is selected by the user.

7. The system in claim 6, wherein the controller compares the score of the user with the score of other users, when the controller performs the foreign language study with other user through the chatting room.

8. The system in claim 1, wherein the multimedia terminal further comprises a multi-channel speaker for exchanging the foreign language study data of the user with that of other user.

9. The system in claim 1, wherein the remote controller is a steering wheel remote controller.

10. The system in claim 1, further comprising a microphone which receives the foreign language study data of the user and sends it to the multimedia terminal through the local wireless communication.

11. A method for studying a foreign language in vehicle, the method comprising:
searching a foreign language study word when a study start command is inputted through Bluetooth wireless communication;
outputting foreign language study data of a native speaker corresponding to the foreign language study word; receiving foreign language study data for the foreign language study word from a user through Bluetooth wireless communication;
evaluating and grading the foreign language study data received from the user by comparing it with the foreign language study data of the native speaker; and
determining the continuation of the study for the foreign language study word according to the grade.

12. The method in claim 11, further comprising storing study history information including a study score, start time, and end time when a study end command is inputted.

13. The method in claim 11, wherein determining the continuation of the study for the foreign language study word comprises outputting native speaker's foreign language study data for a next word when the grade is higher than a given, while requesting the re-pronunciation for a corresponding word when the grade is lower than a given score.

14. The method in claim 11, wherein searching a foreign language study word comprises searching a latest study word, and indicating a study word list when the latest study word does not exist so that the study word is selected by the user.

15. A method for studying a foreign language in vehicle, the method comprising:
selecting a chat room by opening the chat room or searching a chat room list, when a user of a vehicle requests a chat mode;
simultaneously performing a foreign language study with other users through the chat room; and
evaluating the foreign language study score of the user and comparing it with a foreign language study score of the other users.

16. The method in claim 15, wherein simultaneously performing a foreign language study comprises:
searching a foreign language study word; and
outputting foreign language study data of a native speaker corresponding to the foreign language study word; and receiving foreign language study data for the foreign language study word from a user through Bluetooth wireless communication.

17. The method in claim 15, wherein evaluating a foreign language study score comprises grading the foreign language study data received from the user by comparing it with the foreign language study data of the native speaker.

18. The method in claim 15, wherein the score and the comparison result are sent to a study support center to be recorded.
